(19) United States
(12) Patent Application Publication
(10) Pub. No.: US 2005/0062414 A1
(43) Pub. Date: Mar. 24, 2005

(54) Organic electroluminescence display package and method for packaging the same

(76) Inventors: Kun-Hsing Hsiao, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/945,806

(22) Filed: Sep. 20, 2004

(30) Foreign Application Priority Data
Sep. 19, 2003 (TW) 92126000

(51) Int. Cl. H05B 33/04; H05B 33/10

(52) U.S. Cl. 313/512; 313/511; 313/506; 445/25

(57) ABSTRACT

An organic electroluminescence display package includes an organic electroluminescence element (30), a frame (40), and a transparent liquid (56). The organic electroluminescence element has a transparent electrically-conductive substrate (302), an organic electroluminescence layer (306), and a cathode (308). The frame includes a sealant layer (402) and a transparent top cover (404), and the transparent liquid is used to prevent moisture and oxygen from permeating the package. The transparent electrically-conductive substrate, the organic electroluminescence layer and the cathode are stacked from bottom to top in that order. The transparent top cover is mounted on the transparent electrically-conductive substrate via the sealant layer to form an airtight cavity (54), and the transparent liquid is filled in the airtight cavity. The package has the advantages of sufficient permeability and compactness.

### BACKGROUND OF THE INVENTION

1. Field of the Invention

The present invention relates to packages and packaging methods for electroluminescence devices, and particularly to a package and a packaging method for an organic electroluminescence display.

2. The Prior Art

Organic electroluminescent cells are constructed from a laminate of an organic electroluminescence layer and electrodes of opposite polarity, one of the electrodes serving as an electron injector and the other as a hole injector. By applying an appropriate bias, holes and electrons are injected from the hole injector and the electron injector respectively. The appropriate bias produces an external potential which provides the mobility of the holes and electrons in the organic electroluminescence layer. As a result, the holes and electrons recombine and generate energy. A part of the energy stimulates luminescent molecules in the electroluminescence layer to a excited state. When the excited luminescent molecules release energy and return to their base state, a certain proportion of this energy is released as photons which produce illumination. This is the mechanism for electroluminescence. Having properties of self-luminescence, wide viewing angle, high response speed, low driving voltage and full color, organic electroluminescence displays have become a leading technology for so-called next generation flat panel displays.

However, the electrodes are easily deteriorated by moisture and oxygen, and the organic electroluminescence display is easily photodegraded. Further, oxygen provides the path for forming radicals in the electroluminescence layer. The radicals include carbonyl, which breaks the molecular bonds and reduces the luminescent efficiency of the electroluminescence layer. This shortens the lifetime of the organic electroluminescence display. Usually, a package for preventing moisture and oxygen from permeating the organic electroluminescence display is used to ensure operational stability and durability. Also, absorbents are incorporated in the organic electroluminescence display to absorb moisture and oxygen. Further, one or multiple protective layers are coated on the organic electroluminescence display to prevent moisture and oxygen from permeating the package.

FIG. 5 shows a conventional package for an organic electroluminescence display. Referring to FIG. 5, the conventional package includes a frame 10 and an electroluminescence element 20. The electroluminescence element 20 comprises an electrically-conductive glass substrate 201, an anode 202, an organic electroluminescence layer 204, and a cathode 206. The anode 202 is attached to the electrically-conductive glass substrate 201, and the cathode 206 is attached to the organic electroluminescence layer 204. The frame includes a sealant layer 104 and a top cover 106. The top cover 106 is mounted on the electrically-conductive glass substrate 201 by the sealant layer 104, thereby defining a cavity 18 for filling with a gas such as nitrogen gas. The top cover 106 has a protrusion part 1062, and an adhered plate 1064 attached under the protrusion part 1062. The protrusion part 1062 and the adhered plate 1064 form an absorbing cavity 161 that contains absorbents 1611. The function of the absorbents 1611 is to prevent moisture from permeating the package.

However, the absorbents 1611 have a critical moisture-absorbing threshold. When moisture retained in the absorbents 1611 reaches a critical amount, the absorbent 1611 does not function any further, and any new moisture can permeate the package and damage the electrodes 202, 206. Further, the absorbing cavity 161 containing the absorbents 1611 increases the size of the package.

An improved organic electroluminescence display package and a method for the packaging the same which overcome the above-mentioned disadvantages are desired.

### SUMMARY OF THE INVENTION

An object of the present invention is to provide an organic electroluminescence display package with sufficient permeability and which is compact.

In order to achieve the object set forth, an organic electroluminescence display package in accordance with one embodiment of the present invention comprises an organic electroluminescence element, a frame, and a transparent liquid. The organic electroluminescence element comprises a transparent electrically-conductive substrate, an organic electroluminescence layer, and a cathode. The frame comprises a sealant layer and a transparent top cover, and the transparent liquid is used to prevent moisture and oxygen from permeating the package. The transparent electrically-conductive substrate, the organic electroluminescence layer and the cathode are stacked from bottom to top in that order. The transparent top cover is mounted on the transparent electrically-conductive substrate via the sealant layer to form an airtight cavity, and the transparent liquid is filled in the airtight cavity. The package has the advantages of sufficient permeability and compactness.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, cross-sectional view of a first embodiment of an organic electroluminescence display package according to the present invention;

FIGS. 2 to 4 are schematic views of sequential steps for packaging the organic electroluminescence display package of FIG. 1; and

FIG. 5 is a schematic, cross-sectional view of a conventional organic electroluminescence display package.

### DESCRIPTION OF THE PREFERRED EMBODIMENTS

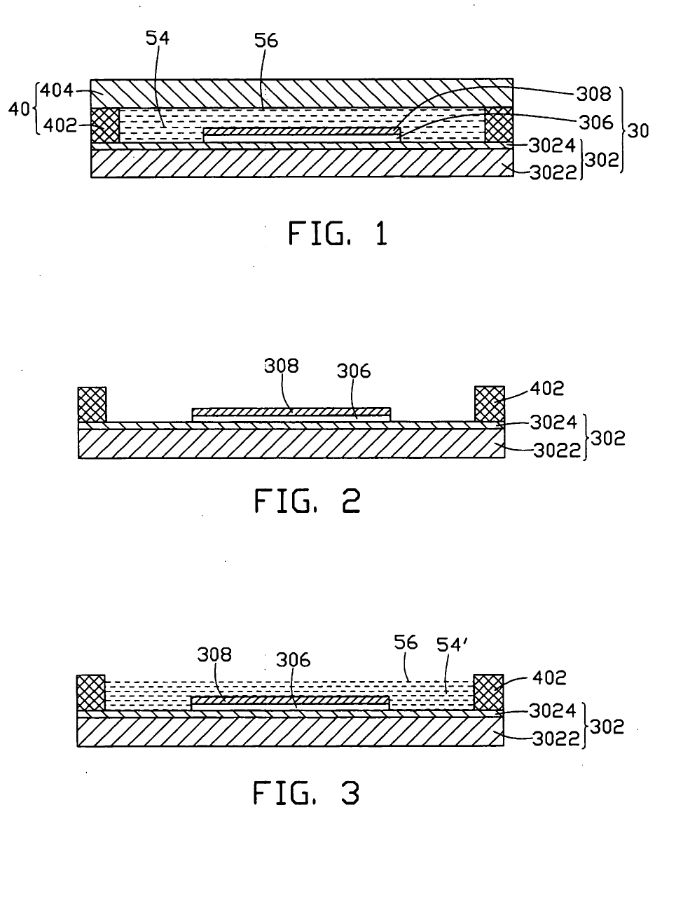

FIG. 1 is a schematic view of an organic electroluminescence display package according to the present invention. The organic electroluminescence display package includes an organic electroluminescence element 30 and a frame 40. The organic electroluminescence element 30 has a transparent electrically-conductive substrate 302, an organic electroluminescence layer 306 and a cathode 308 stacked from bottom to top in that order. The frame 40 includes a sealant layer 402 and a transparent top cover 404. The transparent top cover 404 is mounted on the transparent electrically-conductive substrate 302 via the sealant layer 402, to form an airtight cavity 54 for filling with transparent liquid 56.

The transparent electrically-conductive substrate 302 includes a transparent substrate 3022, and an electrically-conductive layer 3024 formed on the transparent substrate 3022. The transparent substrate 3022 is made of glass or a thin film. The thin film may be polyethylene terephthalate, polyethylene naphthalate, poly-trimethylene terephthalate, poly-butylene terephthalate, or poly-ethersulfone. The electrically-conductive layer 3024 is a transparent indium tin oxide film. The transparent top cover 404 faces the transparent electrically-conductive substrate 302, and is made of transparent glass or a thin film. The thin film may be polyethylene terephthalate, polyethylene naphthalate, or poly-ethersulfone. Respective sizes of the transparent electrically-conductive substrate 302 and the transparent top cover 404 are configured according to the needs of particular applications.

The material of the sealant layer 402 is an ultraviolet curing glue, a thermal curing glue, or a combination of these. The transparent liquid 56 is filled in the airtight cavity 54 to prevent moisture and oxygen from permeating the organic electroluminescence display package. The transparent liquid 56 is poly-vinyl alcohol, polyethylene glycol, polyol, or acrylic resin; that is, a substance which does not react with the organic electroluminescence layer 306 or the cathode 308.

FIGS. 2 to 4 are schematic views of steps in the packaging of the organic electroluminescence display package.

FIG. 2 shows a first step of coating the sealant layer 402 around a periphery of the transparent electrically-conductive substrate 302. The organic electroluminescence layer 306 and the cathode 308 are stacked on the transparent electrically-conductive substrate 302 from bottom to top in that order. A thickness of the sealant layer 402 is substantially equal to a total thickness of the organic electroluminescence layer 306 and the cathode 308.

FIG. 3 shows a second step of filling the transparent liquid 56 into a space 54′ which is defined by the transparent electrically-conductive substrate 302, the organic electroluminescence layer 306, the cathode 308 and the sealant layer 402. A one-drop-fill process system, which is used in the art to fill a liquid crystal panel with liquid crystal material, can be used to fill the transparent liquid 56 into the space 54′.

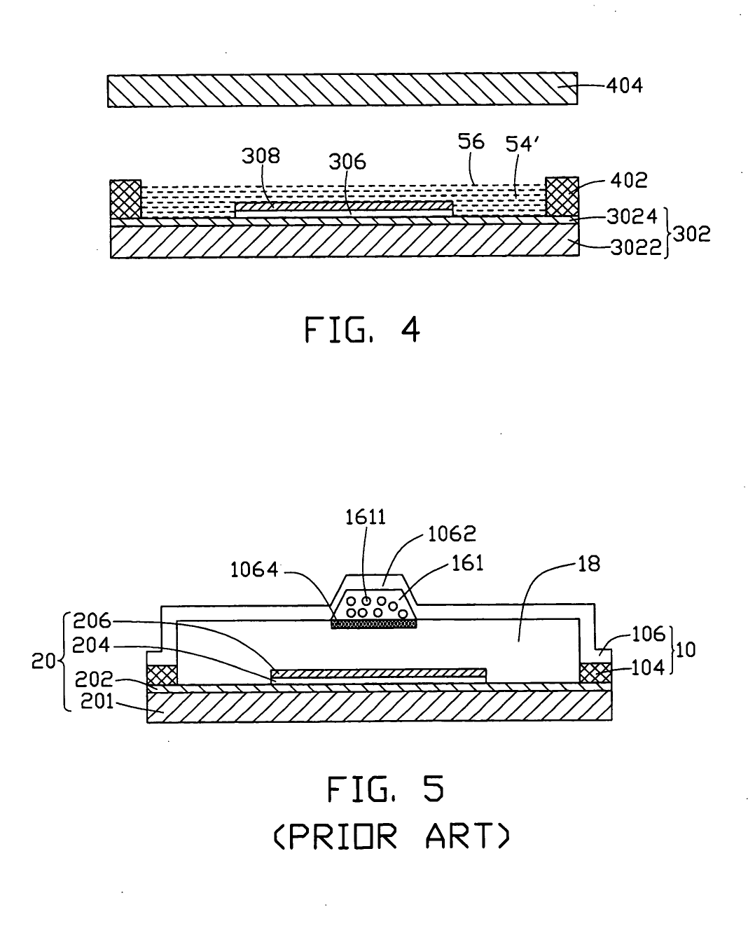

FIG. 4 shows a third step of jointing the transparent electrically-conductive substrate 302 with the transparent top cover 404. The transparent electrically-conductive substrate 302 is placed in a vacuum room (not shown). The transparent top cover 404 is picked up by a vacuum suction device (not shown) in the vacuum room. The suction device shifts the transparent top cover 404 onto and in alignment with the sealant layer 402. A valve (not shown) of the vacuum room is opened. The transparent top cover 404 is thus pressed on the sealant layer 402 by air pressure.

Then, a fourth step of ultraviolet light curing and a fifth step of baking are performed to cure the sealant layer 402. After using an ultraviolet light to cure the sealant layer 402, the cured structure is baked for an hour in a baking oven. The baking temperature is kept at 120° C. The organic electroluminescence display package is thus obtained. The organic electroluminescence display package has the advantages of sufficient permeability and compactness.

The above-described third step of jointing step is optional, and mainly depends on the material of the transparent liquid 56. If the material of the transparent liquid 56 is poly-vinyl alcohol, polyethylene glycol or polyol, the material will remain in the liquid state after the baking step, and thus the transparent top cover 404 is necessary to prevent moisture and oxygen from permeating the organic electroluminescence display package. That is, the jointing step is necessary. If the material of the transparent liquid 56 is acrylic resin, the acrylic resin is changed to a solid state by the baking step. The cured acrylic resin has the functions of both the transparent liquid 56 and the transparent top cover 404, so that the jointing step can be omitted. In such case, the fourth step of curing is performed directly after the second step of filling. The obtained organic electroluminescence display package structure does not include the transparent top cover 404. However, if desired, the transparent top cover 404 can still be provided in order to further ensure that moisture and oxygen are prevented from permeating the organic electroluminescence display package.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An organic electroluminescence display package, comprising:
an organic electroluminescence element comprising a transparent electrically-conductive substrate, an organic electroluminescence layer and a cathode;
a frame comprising a sealant layer and a transparent top cover; and
transparent liquid for preventing moisture and oxygen from permeating the package;
wherein the transparent electrically-conductive substrate, the organic electroluminescence layer and the cathode are stacked from bottom to top in that order, the transparent top cover is mounted on the transparent electrically-conductive substrate via the sealant layer to form an airtight cavity, and the transparent liquid is filled in the airtight cavity.

2. The package of claim 1, wherein the transparent electrically-conductive substrate comprises a transparent substrate and an electrically-conductive layer on the transparent substrate.

3. The package of claim 2, wherein the transparent substrate is made of glass or a thin film.

4. The package of claim 3, wherein the thin film is made of polyethylene terephthalate, polyethylene naphthalate, poly-trimethylene terephthalate, poly-butylene terephthalate, or poly-ethersulfone.

5. The package of claim 1, wherein the transparent liquid is poly-vinyl alcohol, polyethylene glycol, polyol, or acrylic resin.

6. The package of claim 1, wherein the sealant layer is made of an ultraviolet curing glue, a thermal curing glue, or a combination thereof.

7. A packaging method for an organic electroluminescence display, comprising the following steps:
providing a transparent electrically-conductive substrate on which an organic electroluminescence layer and a cathode are stacked from bottom to top in that order;
coating a sealant layer at a periphery of the transparent electrically-conductive substrate, the transparent electrically-conductive substrate, the organic electroluminescence layer, the cathode and the sealant layer cooperatively forming a space;
filling transparent liquid into the space;
jointing the transparent electrically-conductive substrate with a transparent top cover in a vacuum room; and
curing and baking the sealant layer.

8. The packaging method of claim 7, wherein the transparent electrically-conductive substrate comprises a transparent substrate and an electrically-conductive layer on the transparent substrate.

9. The packaging method of claim 8, wherein the transparent substrate is made of glass or a thin film.

10. The packaging method of claim 9, wherein the thin film is made of polyethylene terephthalate, polyethylene naphthalate, poly-trimethylene terephthalate, poly-butylene terephthalate, or poly-ethersulfone.

11. The packaging method of claim 7, wherein the transparent liquid is poly-vinyl alcohol, polyethylene glycol, polyol, or acrylic resin.

12. The packaging method of claim 7, wherein the sealant layer is made of an ultraviolet curing glue, a thermal curing glue, or a combination thereof.

13. An organic electroluminescence display package, comprising:
an organic electroluminescence element comprising a transparent electrically-conductive substrate, an organic electroluminescence layer and a cathode;
a frame comprising a sealant layer; and
cured acrylic resin for preventing moisture and oxygen from permeating the package;
wherein the transparent electrically-conductive substrate, the organic electroluminescence layer and the cathode are stacked from bottom to top in that order, the transparent electrically-conductive substrate and the sealant layer form an airtight cavity, and the cured acrylic resin is in the airtight cavity.

14. The package of claim 13, wherein the transparent electrically-conductive substrate comprises a transparent substrate and an electrically-conductive layer on the transparent substrate.

15. The package of claim 14, wherein the transparent substrate is made of glass or a thin film.

16. The package of claim 15, wherein the thin film is made of polyethylene terephthalate, polyethylene naphthalate, poly-trimethylene terephthalate, poly-butylene terephthalate, or poly-ethersulfone.

17. The package of claim 13, wherein the sealant layer is made of an ultraviolet curing glue, a thermal curing glue, or a combination thereof.

18. The package of claim 13, further comprising a transparent top cover, the transparent top cover being mounted on the transparent electrically-conductive substrate by the sealant layer.

19. A packaging method for an organic electroluminescence display, comprising the following steps:
providing a transparent electrically-conductive substrate on which an organic electroluminescence layer and a cathode are stacked from bottom to top in that order;
coating a sealant layer at a periphery of the transparent electrically-conductive substrate, the transparent electrically-conductive substrate, the organic electroluminescence layer, the cathode and the sealant layer cooperatively forming a space;
filling transparent liquid into the space; and
curing and baking the sealant layer and the transparent liquid.

20. The packaging method of claim 19, wherein the transparent electrically-conductive substrate comprises a transparent substrate and an electrically-conductive layer on the transparent substrate.

21. The packaging method of claim 20, wherein the transparent substrate is made of glass or a thin film.

22. The packaging method of claim 21, wherein the thin film is made of polyethylene terephthalate, polyethylene naphthalate, poly-trimethylene terephthalate, poly-butylene terephthalate, or poly-ethersulfone.

23. The packaging method of claim 19, wherein the transparent liquid is acrylic resin.

24. The package method of claim 19, wherein the sealant layer is made of an ultraviolet curing glue, a thermal curing glue, or a combination thereof.

25. The package of claim 1, wherein the transparent liquid surrounds said organic electroluminescence layer and said cathode except an interface between the organic electroluminescence layer.
